(19) United States
(12) Patent Application Publication
(10) Pub. No.: US 2024/0373861 A1
(43) Pub. Date: Nov. 14, 2024

(54) STABLE OIL-IN-WATER MICROEMULSION COMPOSITIONS

(71) Applicant: S. C. JOHNSON & SON, INC., Racine, WI (US)

(72) Inventors: Chandra Palla VENKATA, Franklin, WI (US); Dallas MATZ, Racine, WI (US); Andrew JOHNSON, Kenosha, WI (US)

(21) Appl. No.: 18/660,155

(22) Filed: May 9, 2024

Related U.S. Application Data
(60) Provisional application No. 63/465,435, filed on May 10, 2023.

(51) Int. Cl. A01N 65/22; A01N 25/04; A01N 65/06; A01N 65/20; A01N 65/44; A01P 7/04

(52) U.S. Cl. CPC A01N 65/22; A01N 25/04; A01N 65/06; A01N 65/20; A01N 65/44; A01P 7/04

(57) ABSTRACT

A composition is disclosed that contains at least one of cedarwood oil, lemongrass oil, peppermint oil, rosemary oil, and sesame oil, and isopropyl alcohol, and water. Disclosed herein also includes a method of killing pests comprising applying to a surface in need thereof a composition containing at least one of cedarwood oil, lemongrass oil, peppermint oil, rosemary oil, and sesame oil, and isopropyl alcohol, and water.

### CROSS REFERENCE TO RELATED APPLICATIONS

This application claims priority to U.S. Provisional Application No. 63/465,435, filed on May 10, 2023, and entitled “STABLE OIL-IN-WATER MICROEMULSION COMPOSITIONS,” the disclosure of which is incorporated by reference herein in its entirety.

### REFERENCE REGARDING FEDERALLY SPONSORED RESEARCH OR DEVELOPMENT

Not applicable.

### SEQUENCE LISTING

Not applicable.

### BACKGROUND

### 1. Technology Field

The present disclosure relates to an insecticidal composition and, more particularly, to a stable oil-in-water microemulsion composition that comprises at least one of cedarwood oil, lemongrass oil, peppermint oil, rosemary oil, and sesame oil, isopropyl alcohol, and water.

### 2. Description of the Background

Insecticidal compositions have been used over the years to prevent insects from attacking humans, animals, and crops. In recent years, consumers have expressed a preference for insecticidal products containing natural essential oil-based actives over products containing synthetic or other pesticides, including products containing inert ingredients. Among essential oil containing insecticides, water-based products are generally preferred by consumers as water-based products tend to possess a milder odor, and deposit less residue or stain on the applied surface, than their oil-based counterparts. However, most water-based insecticidal products in the market require greater than 5% of emulsifiers, surfactants, and cosurfactants, particularly sodium lauryl sulfate, to create stable essential oil-in-water microemulsions. This higher concentration of emulsifiers, surfactants, and cosurfactants often results in an undesired foaming during application of the product.

It is continuously desirable to have water-based insecticidal compositions that may be applied to both humans and pets and comprise essential oil-based actives and inert ingredients with minimal health risk. It is also desirable to have water-based insecticidal compositions having a reduced concentration of emulsifiers, surfactants, and cosurfactants, particularly sodium lauryl sulfate, while still maintaining stable oil-in-water microemulsions.

### SUMMARY

Disclosed herein is a pest control composition including at least one active component, a total surfactant component that includes a primary surfactant and a secondary surfactant, an alcohol, a salt, and water. It is shown that the compositions described herein unexpectedly provide stable oil-in-water microemulsions capable of killing insects effectively and efficiently.

In one aspect, the aforementioned pest control composition further includes at least one additive. In some embodiments, the at least one additive may be selected from glycerin, mixed tocopherols (Vitamin E), and combinations thereof. In some embodiments, the at least one additive comprises about 0.50 wt % to about 2.00 wt %, based on the total weight of the composition. In some embodiments, the at least one additive is 0.50 wt % glycerin, based on the total weight of the composition.

In another aspect, the at least one active component may be selected from cedarwood oil, lemongrass oil, rosemary oil, peppermint oil, sesame oil, and any combinations thereof. In one embodiment, the at least one active component comprises at least one of cedarwood oil, lemongrass oil, peppermint oil, rosemary oil, sesame oil, and any combinations thereof. In one embodiment, the at least one active component comprises cedarwood oil, lemongrass oil, and sesame oil. In one embodiment, the at least one active component comprises cedarwood oil, peppermint oil, and sesame oil. In one embodiment, the at least one active component comprises cedarwood oil, rosemary oil, and sesame oil. In one embodiment, the at least one active component comprises cedarwood oil and sesame oil. In one embodiment, the at least one active component comprises rosemary oil. In one embodiment, the at least one active component comprises cedarwood oil and lemongrass oil. In embodiment, the at least one active component comprises lemongrass oil and rosemary oil. In one embodiment, the at least one active component comprises cedarwood oil. In another aspect, the weight percent of the at least one active component is about 5.80 wt % to about 9.0 wt %, based on the total weight of the composition.

In one aspect, the composition includes a primary surfactant. In some embodiments, the composition may include about 2.20 wt % primary surfactant, based on the total weight of the composition. In some embodiments, the primary surfactant may be sodium lauryl sulfate.

In another aspect, the composition includes a secondary surfactant. In some embodiments, the secondary surfactant may be selected from polyglyceryl-4-oleate, polyglyceryl oleate, decaglycerol monostearate, and any combinations thereof. In some embodiments, about 2.25 wt % to about 4.50 wt % of the composition is secondary surfactant, based on the total weight of the composition.

The composition includes a total surfactant component that includes a primary surfactant and a secondary surfactant. In some embodiments, the composition is about 2.80 wt % to about 6.70 wt % total surfactant component, based on the total weight of the composition.

In one aspect, the composition includes alcohol. In some embodiments, the composition may include about 2.00 wt % to about 15.0 wt % alcohol, or about 5.00 wt % to about 10.0 wt % alcohol, based on the total weight of the composition. In some embodiments, the alcohol may be isopropyl alcohol.

In another aspect, about 74.0 wt % to about 82.0 wt % of the composition may be water, based on the total weight of the composition.

In one aspect, the composition includes salt. In some embodiments, the composition may include about 0.50 wt % to about 3.00 wt % salt, or about 2.00 wt % salt, based on the total weight of the composition. In some embodiments, the salt may be sodium chloride.

In an embodiment, the pest control composition including at least one active component, a total surfactant component comprising a primary surfactant and a secondary surfactant, an alcohol, a salt, and water has an insect/arthropod knockdown rate at 30 seconds greater than or equal to about 90% against India Meal moth, Fruit fly, Mosquito, Carpenter ant, Argentine ant, Pharoah ant, Firebrat, Earwig, House fly, and German cockroach as measured by the Insect/Arthropod Knockdown and Mortality Test and the Cockroach Direct Spray Test.

In an embodiment, the pest control composition including at least one active component, a total surfactant component comprising a primary surfactant and a secondary surfactant, an alcohol, a salt, and water has an insect/arthropod mortality rate at 24 hours of about 100% against India Meal moth, House fly, Fruit fly, Mosquito, Carpenter ant, Argentine ant, Pharoah ant, Firebrat, Common house spider, Earwig, and German cockroach, as measured by the Insect/Arthropod Knockdown and Mortality Test.

In an embodiment, the pest control composition including at least one active component, a total surfactant component comprising a primary surfactant and a secondary surfactant, an alcohol, a salt, and water has an insect/arthropod knockdown rate at 30 seconds greater than or equal to about 90% against German cockroach and an insect mortality rate at 24 hours of greater than about 90% against American cockroach, and 100% against German cockroach, as measured by the Cockroach Direct Spray Test.

In an embodiment, the pest control composition including at least one active component, a total surfactant component comprising a primary surfactant and a secondary surfactant, an alcohol, a salt, and water has an arthropod mortality rate at 24 hours of about 100% against Brown Dog tick as measured by the Tick Direct Spray Test.

In an embodiment, the pest control composition including at least one active component, a total surfactant component comprising a primary surfactant and a secondary surfactant, an alcohol, a salt, and water has an arthropod mortality rate at 24 hours of about 100% against Cat flea as measured by the Flea Direct Spray Test.

In an embodiment, the pest control composition including at least one active component, a total surfactant component comprising a primary surfactant and a secondary surfactant, an alcohol, a salt, and water has an insect knockdown rate at 30 seconds greater than or equal to about 90% and an insect mortality rate at 24 hours of about 100% against the India Meal moth, Fruit fly, Mosquito, Carpenter ant, Argentine ant, Pharoah ant, Firebrat, Earwig, House Fly, and German cockroach as measured by the Insect/Arthropod Knockdown and Mortality Test and the Cockroach Direct Spray Test.

The current disclosure also describes a method of killing insects comprising applying to a surface in need thereof a composition including at least one active component, a total surfactant component that includes a primary surfactant and a secondary surfactant, an alcohol, a salt, and water.

### DETAILED DESCRIPTION OF THE INVENTION

In the pest control field, it is known that consumers desire a product that contains fewer synthetic pesticides and inert ingredients while providing a high efficacy for the knockdown and/or killing of insects. In addition, it is also desirable that the pest control product is water-based, providing a milder odor and less residue on an applied surface, compared to some oil-based products. Moreover, for water-based pest control products, it would be favorable that a lower concentration of emulsifiers, surfactants, and cosurfactants are used in the product to reduce undesirable foaming. Disclosed herein is a reversible emulsion composition for pest control, including at least one active component, a total surfactant component comprising a primary surfactant and a secondary surfactant, an alcohol, a salt, and water.

While specific values chosen for ranges for various embodiments are recited, it is to be understood that, within the scope of the disclosure, the concentrations of components may vary to suit different applications, and also that each of the individual values within the ranges are expressly contemplated by this disclosure.

One aspect of the disclosed technology includes an emulsion composition. An emulsion is defined as a mixture of two or more liquids that are normally immiscible (unmixable or unblendable) owing to liquid-liquid phase separation. In some embodiments, the emulsion composition is reversible. In this disclosure, a reversible emulsion refers to the property of the composition to undergo a reversible phase change (emulsify and/or demulsify). In certain cases, the emulsion composition may demulsify at high or low temperatures (i.e., about 10° C. or more above room temperature or about 10° C. or more below room temperature, or about 20° C. or more above room temperature or about 20° C. or more below room temperature). A ‘reversible emulsion’ or ‘stable emulsion’ composition has the property of returning to a substantially clear, homogenous phase at room temperature with little to no physical agitation, such as stirring or shaking. An unstable emulsion may not return to a to a clear, homogenous phase at room temperature (23° C.). Conversely, an unstable emulsion may only return to a clear, homogenous phase at room temperature under continuous and/or vigorous physical agitation.

One aspect of the disclosed technology comprises at least one active component. An ‘active component’ is a component of the composition which imparts the intended effect of the composition. In the present disclosure, the intended effect of the composition includes pest control by pest knockdown and/or pest mortality. In some embodiments, the at least one active component may include an essential oil. ‘Essential oils’ are defined as concentrated hydrophobic liquids containing volatile chemical compounds from plants. In some embodiments, the at least one active component may include cedarwood oil, lemongrass oil, rosemary oil, peppermint oil, sesame oil, or any combination thereof.

In certain circumstances, the composition may include one or more ingredients eligible for minimum risk pesticide products that are exempt from the Federal Insecticide, Fungicide, and Rodenticide Act (FIFRA) under the Minimum Risk Exemption regulations in 40 U.S. Code of Federal Regulations 152.25 (f), for example, included, but not limited to, those listed as “Active Ingredients Permitted in Exempted Minimum Risk Pesticide Products” in 40 U.S. Code of Federal Regulations 152.25 (f).

The compositions of the present disclosure, and the active component thereof, may also include other active ingredients other than, or in addition to, essential oils.

In certain embodiments, the composition comprises cedarwood oil. In certain embodiments, the composition comprises between about 0.5% to about 15% by weight of cedarwood oil, based on the total weight of the composition. In certain embodiments, the composition comprises between about 0.6% to about 14% by weight of cedarwood oil, based on the total weight of the composition. In certain embodiments, the composition comprises between about 0.8% to about 12% by weight of cedarwood oil, based on the total weight of the composition. In certain embodiments, the composition comprises between about 0.9% to about 11% by weight of cedarwood oil, based on the total weight of the composition. In certain embodiments, the composition comprises between about 1% to about 10% by weight of cedarwood oil, based on the total weight of the composition. In certain embodiments, the composition comprises between about 2% to about 8% by weight of cedarwood oil, based on the total weight of the composition. In certain embodiments, the composition comprises between about 3% to about 7% by weight of cedarwood oil, based on the total weight of the composition. In certain embodiments, the composition comprises between about 4% to about 6% by weight of cedarwood oil, based on the total weight of the composition. In certain embodiments, the composition comprises between about 4% to about 5% by weight of cedarwood oil, based on the total weight of the composition. In accordance with exemplary embodiments, cedarwood oil is present in an amount of about 1.5%, about 4.2%, about 5.7%, and about 9.0% by weight of the total composition. While specific values chosen for this embodiment are recited, it is to be understood that, within the scope of the disclosure, the concentrations of cedarwood oil may vary to suit different applications. The concentration ranges of cedarwood oil will vary based on the concentrations of the additional components of the composition, including, but not limited to, total surfactant component comprising a primary surfactant and a secondary surfactant, alcohol, salt, and water.

In certain embodiments, the composition comprises sesame oil. In certain embodiments, the composition comprises between about 0.001% to about 1% by weight of sesame oil, based on the total weight of the composition. In certain embodiments, the composition comprises between about 0.003% to about 0.8% by weight of sesame oil, based on the total weight of the composition. In certain embodiments, the composition comprises between about 0.005% to about 0.6% by weight of sesame oil, based on the total weight of the composition. In certain embodiments, the composition comprises between about 0.01% to about 0.5% by weight of sesame oil, based on the total weight of the composition. In certain embodiments, the composition comprises between about 0.03% to about 0.4% by weight of sesame oil, based on the total weight of the composition. In certain embodiments, the composition comprises between about 0.04% to about 0.3% by weight of sesame oil, based on the total weight of the composition. In certain embodiments, the composition comprises between about 0.05% to about 0.2% by weight of sesame oil, based on the total weight of the composition. In certain embodiments, the composition comprises between about 0.08% to about 0.15% by weight of sesame oil, based on the total weight of the composition. In accordance with an exemplary embodiment, the sesame oil is present in an amount of about 0.1% by weight of the total composition. While specific values chosen for this embodiment are recited, it is to be understood that, within the scope of the disclosure, the concentrations of the sesame oil may vary to suit different applications. The concentration ranges of sesame oil will vary based on the concentrations of the additional components of the insecticidal composition, including, but not limited to, total surfactant component comprising a primary surfactant and a secondary surfactant, alcohol, salt, and water.

In certain embodiments, the composition comprises lemongrass oil. In certain embodiments, the composition comprises between about 0.001% to about 10.0% by weight of lemongrass oil, based on the total weight of the composition. In certain embodiments, the composition comprises between about 0.50% to about 8.00% by weight of lemongrass oil, based on the total weight of the composition. In certain embodiments, the composition comprises between about 1.00% to about 5.00% by weight of lemongrass oil, based on the total weight of the composition. In certain embodiments, the composition comprises between about 1.00% to about 4.50% by weight of lemongrass oil, based on the total weight of the composition. In certain embodiments, the composition comprises between about 0.80% to about 5.50% by weight of lemongrass oil, based on the total weight of the composition. In certain embodiments, the composition comprises between about 0.90% to about 4.60% by weight of lemongrass oil, based on the total weight of the composition. In certain embodiments, the composition comprises between about 0.95% to about 4.75% by weight of lemongrass oil, based on the total weight of the composition. In certain embodiments, the composition comprises between about 1.40% to about 4.60% by weight of lemongrass oil, based on the total weight of the composition. In accordance with exemplary embodiments, the lemongrass oil is present in an amount of about 1.50%, about 3.0%, and about 4.5% by weight of the total composition. While specific values chosen for this embodiment are recited, it is to be understood that, within the scope of the disclosure, the concentrations of the lemongrass oil may vary to suit different applications. The concentration ranges of lemongrass oil will vary based on the concentrations of the additional components of the insecticidal composition, including, but not limited to, total surfactant component comprising a primary surfactant and a secondary surfactant, alcohol, salt, and water.

In certain embodiments, the composition comprises rosemary oil. In certain embodiments, the composition comprises between about 0.001% to about 10.0% by weight of rosemary oil, based on the total weight of the composition. In certain embodiments, the composition comprises between about 0.50% to about 8.00% by weight of rosemary oil, based on the total weight of the composition. In certain embodiments, the composition comprises between about 1.00% to about 7.00% by weight of rosemary oil, based on the total weight of the composition. In certain embodiments, the composition comprises between about 1.00% to about 6.50% by weight of rosemary oil, based on the total weight of the composition. In certain embodiments, the composition comprises between about 0.80% to about 6.00% by weight of rosemary oil, based on the total weight of the composition. In certain embodiments, the composition comprises between about 0.90% to about 6.60% by weight of rosemary oil, based on the total weight of the composition. In certain embodiments, the composition comprises between about 0.95% to about 6.75% by weight of rosemary oil, based on the total weight of the composition. In certain embodiments, the composition comprises between about 1.40% to about 6.50% by weight of rosemary oil, based on the total weight of the composition. In accordance with exemplary embodiments, the rosemary oil is present in an amount of about 1.50%, about 3.0%, and about 6.0% by weight of the total composition. While specific values chosen for this embodiment are recited, it is to be understood that, within the scope of the disclosure, the concentrations of the rosemary oil may vary to suit different applications. The concentration ranges of rosemary oil will vary based on the concentrations of the additional components of the insecticidal composition, including, but not limited to, total surfactant component comprising a primary surfactant and a secondary surfactant, alcohol, salt, and water.

In certain embodiments, the composition comprises peppermint oil. In certain embodiments, the composition comprises between about 0.001% to about 2% by weight of peppermint oil, based on the total weight of the composition. In certain embodiments, the composition comprises between about 0.1% to about 1.8% by weight of peppermint oil, based on the total weight of the composition. In certain embodiments, the composition comprises between about 0.5% to about 1.6% by weight of peppermint oil, based on the total weight of the composition. In certain embodiments, the composition comprises between about 0.1% to about 2.5% by weight of peppermint oil, based on the total weight of the composition. In certain embodiments, the composition comprises between about 0.3% to about 1.8% by weight of peppermint oil, based on the total weight of the composition. In certain embodiments, the composition comprises between about 0.8% to about 1.8% by weight of peppermint oil, based on the total weight of the composition. In certain embodiments, the composition comprises between about 1.3% to about 1.8% by weight of peppermint oil, based on the total weight of the composition. In certain embodiments, the composition comprises between about 1.2% to about 1.75% by weight of peppermint oil, based on the total weight of the composition. In accordance with an exemplary embodiment, the peppermint oil is present in an amount of about 1.5% by weight of the total composition. While specific values chosen for this embodiment are recited, it is to be understood that, within the scope of the disclosure, the concentrations of the peppermint oil may vary to suit different applications. The concentration ranges of peppermint oil will vary based on the concentrations of the additional components of the insecticidal composition, including, but not limited to, total surfactant component comprising a primary surfactant and a secondary surfactant, alcohol, salt, and water.

Another aspect of the disclosed technology is a total surfactant component. The total surfactant component includes a primary surfactant and a secondary surfactant. A surfactant is defined as a compound that decreases the surface tension between two liquids, between a gas and a liquid, or interfacial tension between a liquid and a solid. ‘Surfactant’ may also be referred to ‘emulsifier’ in the present disclosure. In some embodiments, a primary surfactant may include sodium lauryl sulfate. In other embodiments, a secondary surfactant may include polyglyceryl-4-oleate, polyglyceryl oleate, decaglycerol monosterate or any combination thereof.

To create stable oil-in-water emulsion compositions, surfactants are typically used at concentrations of greater than 5%. This is demonstrated in U.S. Pat. Nos. 10,752,785, 8,778,910, U.S. Patent Application Publication 2010/0173782, U.S. Pat. Nos. 10,980,888, 11,535,793, and U.S. Patent Application Publication 2006/0165739, each of which is incorporated, in their entireties and for all purposes, herein. Unexpectedly, stable emulsion compositions were created containing less than about 5% total surfactant component by weight. Even more surprising, stable emulsion compositions were created including less than 3% total surfactant component by weight. In one embodiment, the composition may include about 2.80% to about 4.50% total surfactant component based on weight of the total composition. The stable emulsion compositions disclosed herein may be used with a wide variety of active components. Further, the stable emulsion compositions as disclosed herein possess a lower viscosity compared to compositions with greater that 5% surfactant, which allows the presently disclosed stable emulsion composition to be used with a number of different delivery systems, including, but not limited to, aerosols, trigger sprays, mists, etc. Further, the lower concentration of surfactants used in the stable emulsion compositions disclosed herein result in reduced foaming of the composition during use.

In certain embodiments, the composition comprises a total surfactant component including primary and secondary surfactants. As used herein, “surfactant” and “emulsifier” are equivalent. In certain embodiments, the composition comprises about 0.1% to about 6.7% by weight total surfactant component, based on the total weight of the composition. In certain embodiments, the composition comprises about 0.3% to about 6.0% by weight total surfactant component, based on the total weight of the composition. In certain embodiments, the composition comprises about 0.5% to about 5.5% by weight total surfactant component, based on the total weight of the composition. In certain embodiments, the composition comprises about 1% to about 5% by weight total surfactant component, based on the total weight of the composition. In certain embodiments, the composition comprises about 1.5% to about 5.0% by weight total surfactant component, based on the total weight of the composition. In certain embodiments, the composition comprises about 2.5% to about 4.5% by weight total surfactant component, based on the total weight of the composition. In certain embodiments, the total surfactant component is selected from the group consisting of sodium lauryl sulfate, polyglyceryl oleate, decaglycerol monostearate, and any combinations thereof. In certain embodiments, the total surfactant component comprises sodium lauryl sulfate. In certain embodiments, the total surfactant component comprises at least one of polyglyceryl oleate and decaglycerol monostearate. In certain embodiments, the total surfactant component comprises sodium lauryl sulfate, and at least one of polyglyceryl oleate and decaglycerol monostearate. In certain embodiments, the polyglyceryl oleate is selected from the group consisting of polyglyceryl-4-oleate, polyglyceryl-3-oleate, polyglyceryl-10-monooleate, polyglyceryl-10-dioleate, and any combinations thereof. It is envisioned that other surfactants may be used, including, but not limited to, those disclosed in U.S. Pat. No. 8,778,910, hereby incorporated by reference in its entirety and for any purpose.

In certain embodiments, the composition comprises a primary surfactant. In some embodiments the primary surfactant may be sodium lauryl sulfate. In some embodiments, the composition comprises about 0.5% to about 5% by weight sodium lauryl sulfate, based on the total weight of the composition. In certain embodiments, the composition comprises about 0.8% to about 4.5% by weight sodium lauryl sulfate, based on the total weight of the composition. In certain embodiments, the composition comprises about 1% to about 4% by weight sodium lauryl sulfate, based on the total weight of the composition. In certain embodiments, the composition comprises about 1.5% to about 3.5% by weight sodium lauryl sulfate, based on the total weight of the composition. In certain embodiments, the composition comprises about 2% to about 3% by weight sodium lauryl sulfate, based on the total weight of the composition. In certain embodiments, the composition comprises about 2% to about 2.5% by weight sodium lauryl sulfate, based on the total weight of the composition.

In certain embodiments, the composition comprises a secondary surfactant. In some embodiments the secondary surfactant may be polyglyceryl oleate or decaglycerol monostearate. In some embodiments, the composition comprises about 0.4% to about 5% by weight polyglyceryl oleate, based on the total weight of the composition. In certain embodiments, the composition comprises about 0.5% to about 4.5% by weight polyglyceryl oleate, based on the total weight of the composition. In certain embodiments, the composition comprises about 0.5% to about 4% by weight polyglyceryl oleate, based on the total weight of the composition. In certain embodiments, the composition comprises about 0.6% to about 3.5% by weight polyglyceryl oleate, based on the total weight of the composition. In certain embodiments, the composition comprises about-2.3%, or 4.5% by weight polyglyceryl oleate, based on the total weight of the composition. In certain embodiments, the composition comprises about 0.5% to about 4% by weight decaglycerol monostearate, based on the total weight of the composition. In certain embodiments, the composition comprises about 1% to about 3% by weight decaglycerol monostearate, based on the total weight of the composition. In certain embodiments, the composition comprises about 1.5% to about 2.5% by weight decaglycerol monostearate, based on the total weight of the composition. In certain embodiments, the composition comprises about 2% by weight decaglycerol monostearate, based on the total weight of the composition.

While specific values chosen for exemplified embodiments are recited, it is to be understood that, within the scope of the disclosure, the concentrations of primary surfactant, secondary surfactant, and total surfactant component may vary to suit different applications. The concentration ranges of primary surfactant, secondary surfactant, and total surfactant component will vary based on the additional components of the insecticidal composition, including, but not limited to, the at least one of active component, isopropyl alcohol, salt, and water.

Another aspect of the composition includes an alcohol. An alcohol is defined as any of a class of organic compounds characterized by one or more hydroxyl (—OH) groups attached to a carbon atom of an alkyl group (hydrocarbon chain). In some embodiments the alcohol may be isopropyl alcohol, ethanol, butanol, or isobutanol. In certain embodiments, the composition comprises between about 0.1% to about 30% by weight of isopropyl alcohol, based on the total weight of the composition. In certain embodiments, the composition comprises between about 0.5% to about 25% by weight of isopropyl alcohol, based on the total weight of the composition. In certain embodiments, the composition comprises between about 1% to about 20% by weight of isopropyl alcohol, based on the total weight of the composition. In certain embodiments, the composition comprises between about 1.5% to about 19% by weight of isopropyl alcohol, based on the total weight of the composition. In certain embodiments, the composition comprises between about 2% to about 18% by weight of isopropyl alcohol, based on the total weight of the composition. In certain embodiments, the composition comprises between about 2.5% to about 16% by weight of isopropyl alcohol, based on the total weight of the composition. In certain embodiments, the composition comprises between about 3% to about 15% by weight of isopropyl alcohol, based on the total weight of the composition. In certain embodiments, the composition comprises between about 4% to about 12% by weight of isopropyl alcohol, based on the total weight of the composition. In certain embodiments, the composition comprises between about 5% to about 10% by weight of isopropyl alcohol, based on the total weight of the composition. In accordance with exemplary embodiments, the isopropyl alcohol is present in an amount of between about 5%, to about 6.2%, or about 10% by weight of the total composition. While specific values chosen for these embodiments are recited, it is to be understood that, within the scope of the disclosure, the concentrations of the isopropyl alcohol may vary to suit different applications, and that each of the individual values within the ranges are contemplated by this disclosure. The concentration ranges of isopropyl alcohol will vary based on the concentrations of the additional components of the composition, including, but not limited to, the at least one active component, total surfactant component including the primary surfactant and the secondary surfactant, salt, and water.

In another aspect, the composition disclosed herein may also include a salt. A ‘salt’ is defined as a chemical compound consisting of an ionic assembly of positively charged cations and negatively charged anions. It is envisioned that the salt may include, but is not limited to, sodium chloride, potassium chloride, magnesium chloride, sodium sulfate, potassium sulfate, and the like, including mono-, di-, and trivalent salts. In one embodiment, the salt may be sodium chloride. In some embodiments, the composition may include about 0.50 wt % to about 5.00 wt % salt, about 1.00 wt % to about 3.00 wt % salt, or about 2.00 wt % salt, based on the total weight of the composition.

In another aspect, the composition may contain at least one additive. An ‘additive’ is defined as a substance added to the composition to improve or preserve the composition. In some embodiments additives may include mixed tocopherols (Vitamin E), glycerin, and any combination thereof. Additives may include excipients, buffers, or substances intended to alter the pH of the composition. In certain embodiments, the composition comprises about 0.2% to about 8% by weight of the at least one additive, based on the total weight of the composition. In certain embodiments, the composition comprises about 0.4% to about 3.5% by weight of the at least one additive, based on the total weight of the composition. In certain embodiments, the composition comprises about 1% to about 7% by weight of the at least one additive, based on the total weight of the composition. In certain embodiments, the composition comprises about 2% to about 5% by weight of the at least one additive, based on the total weight of the composition. In certain embodiments, the composition comprises about 2.5% to about 4% by weight of the at least one additive, based on the total weight of the composition. While specific values chosen for exemplified embodiments are recited, it is to be understood that, within the scope of the disclosure, the concentration of the at least one additive may vary to suit different applications. The concentration ranges of the at least one additive will vary based on the additional components of the composition, including, but not limited to, the at least one active component, total surfactant component including a primary surfactant and a secondary surfactant, alcohol, salt, and water.

In certain embodiments, the composition comprises about 60% to about 90% by weight water, based on the total weight of the composition. In certain embodiments, the composition comprises about 63% to about 88% by weight water, based on the total weight of the composition. In certain embodiments, the composition comprises about 65% to about 85% by weight water, based on the total weight of the composition. In certain embodiments, the composition comprises about 70% to about 83% by weight water, based on the total weight of the composition. In certain embodiments, the composition comprises about 75% to about 82% by weight water, based on the total weight of the composition. In accordance with an exemplary embodiment, the water is present in an amount of about 81.64%, about 75.77%, about 78.52%, about 76.02%, about 77.02%, or about 80.14% by weight of the total composition. While specific values chosen for these embodiments are recited, it is to be understood that, within the scope of the disclosure, the concentrations of water may vary to suit different applications. The concentration ranges of water will vary based on the additional components of the composition, including, but not limited to, the at least one active component, total surfactant component including a primary surfactant and a secondary surfactant, alcohol, and salt.

Unexpectedly, a stable emulsion composition does not form when any one of a primary surfactant, a secondary surfactant, a salt, or an alcohol are absent from the composition. Also surprisingly, a stable emulsion composition formed with the addition of one active component, two active components, or three active components. In some embodiments, the active components in stable emulsion compositions include, for example:
i) cedarwood oil, lemongrass oil, and sesame oil
ii) cedarwood oil, peppermint oil, and sesame oil
iii) cedarwood oil, rosemary oil, and sesame oil
iv) cedarwood oil and sesame oil
v) rosemary oil
vi) lemongrass oil and rosemary oil
vii) cedarwood oil

Further, a stable emulsion composition forms when the weight percent of at least one active component or the cumulative weight percent of two or more active components account for as low as about 5.80% by weight of the total composition to as high as about 9.00% by weight of the total composition.

In another aspect of the disclosed technology, the emulsion composition may be used for pest control. Surprisingly, the previously described emulsion composition is effective at eliciting knockdown or killing a range of insects (e.g., acting as an insecticide). The emulsion composition has knockdown or mortality efficacies in one or more pests, including flies, ants, cockroaches, spiders, mosquitoes, fruit flies, moths, or any combination thereof. In some embodiments, the emulsion composition may demonstrate pest control efficacy on (Campanotus floridanus, Blatella germanica, Aedes aegypti, Musca domestica, Rhipicephalus sanguineus, Euborellia annulipes, Thermobia domestica, Monomorium pharaonic, Linepithema humile, Parasteatoda tepidariorum, Periplaneta americana, Drosophila melanogaster, Plodia interpunctella, or any combination thereof.

In some embodiments, the emulsion composition may be applied to a person, a surface, an area, or an animal in need of pest control.

It was unexpectedly discovered that an insecticidal composition including at least one active component, a total surfactant component including a primary surfactant and a secondary surfactant, an alcohol, a salt, and water provides a stable oil-in-water microemulsion that protects both humans and pets, and is efficacious against insects of interest such as, for example, ants, fleas, ticks, mosquitoes, and other pests. Further, the compositions are reversible in nature-if the composition undergoes phase changes at low and/or high temperatures, it returns to a clear homogeneous phase at room temperature, with no or gentle shaking. Typically, to create stable oil-in-water microemulsions, emulsifiers or surfactants, for example sodium lauryl sulfate, are used at concentrations considerably greater than 5% to maintain a stable oil-in-water microemulsion. As described in this disclosure, stable oil-in-water microemulsions were created with as little as 4.2% total emulsifier/surfactant concentration (herein, the total surfactant component). Moreover, the compositions described herein are pH stable and provide parity efficacy with the insects of interest. Lastly, the compositions described herein are of low viscosity, allowing them to be used with a number of different delivery systems (e.g. aerosols, trigger sprays, mists, etc.).

The compositions described herein present stable oil-in-water microemulsions that are highly efficacious in the knockdown and killing of pests. In particular, the composition described herein achieves a pest knockdown rate as much as 100% within 30 seconds, and a pest mortality rate as much as 100% within 24 hours. In certain embodiments, the composition has an insect knockdown rate at 30 seconds greater than or equal to about 90% and an insect mortality rate at 24 hours of about 100%, as measured by the methods described below. In some embodiments, the composition has an insect knockdown rate at 30 seconds greater than or equal to about 90% and an insect mortality rate at 24 hours of about 100% against the India Meal moth, Fruit fly, Mosquito, Carpenter ant, Argentine ant, Pharoah ant, Firebrat, Earwig, House Fly, and German cockroach as measured by the Insect/Arthropod Knockdown and Mortality Test. In another embodiment, the composition has an arthropod mortality rate at 24 hours of about 100% against Cat flea as measured by the Flea Direct Spray Test. In some embodiments, the composition has an arthropod mortality rate at 24 hours of about 100% against Brown Dog tick as measured by the Tick Direct Spray Test. In some embodiments, the composition has an insect knockdown rate at 30 seconds greater than or equal to about 90% against German cockroach and an insect mortality rate at 24 hours of about >90% against American cockroach, and 100% against German cockroach as measured by the Cockroach Direct Spray Test. In other embodiments, the composition has an insect mortality rate at 24 hours of about 100% against the India Meal moth, House fly, Fruit fly, Mosquito, Carpenter ant, Argentine ant, Pharoah ant, Firebrat, Common house spider, Earwig, and German cockroach, as measured by the Insect/Arthropod Knockdown and Mortality Test. In other embodiments, the composition has an insect knockdown rate at 30 seconds greater than or equal to about 90% against the India Meal moth, Fruit fly, Mosquito, Carpenter ant, Argentine ant, Pharoah ant, Firebrat, Earwig, House fly, and German cockroach, as measured by the Insect/Arthropod Knockdown and Mortality Test.

The current disclosure also describes a method of killing insects including applying to a surface in need thereof a reversible emulsion composition for pest control, including at least one active component, the total surfactant component including the primary surfactant and the secondary surfactant, the salt, and the water. “Applying” may include wiping, spraying, pouring, or orienting the surface closely adjacent to the composition, or otherwise exposing a surface to the composition.

Other plant-based insecticidal natural oils, natural oil extracts, or natural oil fractions that may be contained in the embodiments of compositions described herein may comprise neem oil, karanja oil, clove oil, thyme oil, oregano oil, garlic oil, anise oil, lime oil, lavender oil, thymol (found in oregano oil and thyme oil), p-cymene (found in oregano oil and thyme oil), 1,8-cineole (found in thyme oil and peppermint oil), eugenol (found in clove oil and cinnamon oil), limonene (found in cinnamon, peppermint, and lime oil), alpha-pinene (found in cinnamon oil, geranium oil, and lime oil), carvacrol (found in oregano oil, thyme oil, and clove oil), gamma-terpinene (found in oregano oil and lime oil), geraniol (found in thyme oil and geranium oil), alpha-Terpineol (found in thyme oil and anise oil), beta-caryophyllene (found in clove oil, cinnamon oil, and peppermint oil) and linalool (found in thyme oil, cinnamon oil and geranium oil, amongst others), or mixtures thereof. In other embodiments, the insecticidal natural oil may comprise any oil having as a constituent one of the following compounds, or a combination of the following compounds: azadirachtin, nimbin, nimbinin, salannin, gedunin, geraniol, geranial, gamma-terpinene, alpha-terpin-eol, beta-caryophyllene, terpinen-4-ol, myrcenol-8, thuya-nol-4, benzyl alcohol, cinnamaldehyde, cinnamyl acetate, alpha-pinene, geranyl acetate, citronellol, citronellyl formate, isomenthone, 10-epi-gamma-eudesmol, 1,5-dimethyl-1-vinyl-4-hexenylbutyrate, 1,3,7-octatriene, eucalyptol, camphor, diallyl disulfide, methyl allyl trisulfide, 3-vinyl-4H-1,2 dithiin, 3-vinyl-1,2 dithiole-5-cyclohexane, diallyl trisulfide, anethole, methyl chavicol, anisaldehyde, estragole, linalyl acetate, geranial, beta-pinene, thymol, carvacrol, p-cymene, beta-myrcene, alpha-myrcene, 1,8-cin-eole, eugenol, limonene, alpha-pinene, menthol, menthone, linalool, or mixtures thereof.

In further embodiments, other plant-based essential oils or extracts or fractions thereof that may be contained in the embodiments of compositions described herein may comprise alpha- or beta-pinene; alpha-camp-holenic aldehyde; alpha-citronellol; alpha-iso-amyl-cinnamic (e.g., amyl cinnamic aldehyde); alpha-pinene oxide; alpha-cinnamic terpinene; alpha-terpineol (e.g., 1-methyl-4-isopropyl-1-cyclohexen-8-ol); lamda-terpinene; achillea; aldehyde C16 (pure); allicin; alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borneol; calamus; camphor; cananga oil (e.g., java); cardamom; carnation (e.g., dianthus caryophyllus); carvacrol; carveol; cassia; castor; cedar (e.g., hinoki); chamomile; cineole; cinnamaldehyde; cinnamic alcohol; cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; d-dihydrocarvone; decyl aldehyde; diallyl disulfide; diethyl phthalate; dihydroanethole; dihydrocarveol; dihy drolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Femiol™; fish; florazon (e.g., 4-ethyl-.alpha., .alpha.-dimethyl-benzenepropanal); galaxolide; geraniol (e.g., 2-trans-3,7-dimethyl-2,6-octadien-8-ol); geraniol; geranyl acetate; geranyl nitrile; ginger; grapefruit; guaiacol; guaiacwood; gurjun balsam; heliotropin; herbanate (e.g., 3-(1-methyl-ethyl) bicyclo(2,2,1) hept-5-ene-2-carboxylic acid ethyl ester); hiba; hydroxycitronellal; i-carvone; i-methylacetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalyl acetate; linseed; litsea cubeba; I-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methylcyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., Citrus aurantium dulcis); orris (e.g., Iris florentina) root; para-cymene; para-hydroxy phenyl butanone crystals (e.g., 4-(4-hydroxphenyl)-2-butanone); passion palmarosa oil (e.g., Cymbopogon martini), patchouli (e.g., Pogostemon cablin), p-cymene; pennyroyal oil; pepper; peppermint (e.g., Mentha piperita), perillaldehyde; petitgrain (e.g., Citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; ryu; sage; sandalwood (e.g., Santa-lum album), sandenol; sassafras; sesame; soybean; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (methyl salicylate) oils, or mixtures thereof.

Other suitable essential oils for use in the compositions described herein include Absinth Oil, Almond Oil, Ambrette Seed Oil, Amyris Oil, Angelica Root Oil, Anethole 20/21 natural, Angelica Seed Oil, Aniseed Oil China star, Anise Star Oil, Balsam Fir Oil, Balsam Oil, Basil Oil, Bay Oil, Bergamot Oil, Birch Sweet Oil, Birch Tar Oil, Bitter Almond Oil, Bitter Orange Oil Cold Pressed, Black Pepper Oil Black Pepper Oleoresin 40/20, Bois de Rose, Buchu Oil, Cabreuva Oil, Cade Oil, Cajeput Oil, Calamus Oil, Camphor Oil White, Cananga Oil, Capsicum Oil, Caraway Seed Oil, Cardamom Seed Oil, Carrot Seed Oil, Cassia Oil, Cedar leaf Oil, Cedarwood Oil, Celery Leaf Oil, Celery Seed Oil, Chamomile Flower Oil, Chenopodium Oil (Wormseed), Cinnamon Bark Oil, Cinnamon Leaf Oil, Cistus Oil, Citronella Oil, Citronellol Terpenes, Clary Sage Oil, Clove Bud Oil, Clove Leaf Oil, Clove Stem Oil, Cognac Oil Green, Cognac Oil White, Copaiba Oil, Coriander Leaf Oil, Coriander Seed Oil, Cornmint Oil (Mentha Arvensis), Cumin Seed Oil, Cyclamen Oil, Cypress Oil, Davana Oil, Dill Herb Oil, Erigeron Oil, Estragon Oil (Tarragon Oil), Eucalyptus Oil, Fennel Oil Bitter, Fennel Oil Sweet, Fir Needle Oil, Galbanum Oil, Garlic Oil, Geranium Oil, Ginger Oil, Grapefruit Oil 10-Fold, Grapefruit Oil 5-Fold, Grapefruit Oil Cold Pressed, Grapefruit Oil Terpenes, Guaiac Wood Oil, Gurjun Balsam, Hemlock Oil (Spruce), Ho Leaf Oil, Ho Wood Oil, Hyssop Oil, Jasmin Oil, Juniper Berry Oil, Laurel Leaf Oil, Lavandin Oil, Lavender Oil, Lavender Spike Oil, Lemon Oil 10-Fold, Lemon Oil 5-Fold, Lemon Oil Cold Pressed, Lemon Oil Distilled, Lemon Oil Terpenes, Lemon Oil Washed, Lemongrass Oil, Lemongrass Oil Terpeneless, Lime Oil 5-Fold, Lime Oil Distilled, Lime Oil Terpenes, Lime Oil Washed, Litsea Cubeba Berry Oil, Mace Oil, Mandarin Oil Cold Pressed, Marjoram Oil Sweet, Musk Oil, Myrtel Oil, Neroli Oil, Nutmeg Oil, Ocotea Cymbarum Oil, Onion Oil, Orange Oil Bitter Cold Pressed, Orange Oil 10-Fold, Orange Oil20-Fold, Orange Oil 5-Fold, Orange Oil Bitter 5-Fold, Orange Oil Cold Pressed, Orange Oil Terpeneless, Oregano Oil, Origanum Oil, Palmarosa Oil, Parsley Leaf Oil, Parsley Seed Oil, Patchouli Oil, Pennroyal Oil, Pepper Oil Black, Peppermint Oil, Petitgrain Oil, Pimenta Berry Oil, Pimenta Leaf Oil, Pine Needle Oil, Pine Oil Scotch, Pine Oil White, Rosalin Oil, Rose Oil, Sage Clary Oil, Sage Oil, Sandalwood Oil, Sassafras Oil, Savory Oil, Spike Lavender Oil (Lavender Spike), Spruce Oil (Hemlock), Star Anise Oil, Styrax Oil, Tagetes Oil, Tangelo Oil, Tangerine Oil, Tangerine Oil 5-Fold, Tangerine Oil Terpenes, Tarragon Oil (Estragon Oil), Tea Tree Oil, Thyme Oil, Thyme Oil White, Tumeric Oil, Purpentine Oil, Valerian Oil, Vanilla beans abs., Vetiver Oil, Wintergreen Oil (Methyl Salicylate Natural), Wormseed Oil, Wormwood Oil, and Ylang Ylang Oil.

As used herein, “sesame oil” refers to both extracted and synthetic versions of vegetable oil derived from sesame seeds. Sesame oil has at least one of the following constituents: sesamin, sesamolin, sesaminol, γ-tocopherol, palmitic acid, oleic acid, linoleic acid, linolenic acid, β-sitosterol, campesterol, stigmasterol, Δ⁵-avenasterol, sitostanol, campestanol, and phytosterols.

As used herein, “lemongrass oil” refers to both extracted and synthetic versions of oils of Cymbopogon, also known as barbed wire grass, silky heads, Cochin grass, Malabar grass, oily heads, citronella grass, or fever grass. Lemongrass oil has at least one of the following constituents: tricyclene, pinene, camphene, 3-carene, β-myrcene, limonene, β-ocimene, cineole, β-ocimene, n-octanal, 6-methyl-hepten-2-one, myrtanal, β-citronellal, linalool, β-caryophyllene, β-citral, sabinol, α-cyclocitral, borneol, neryl acetate, germacrene-D, β-citronellol, zingiberene, α-citral, verbenone, nerol, γ-cadinene, Z-carveol, geranial butyrate, caryophyllene oxide, epi-cubenol, isoeugenol, nerolic acid, monoterpene hydrocarbons, oxygenated monoterpenes, sesquiterpene hydrocarbons, and oxygenated sesquiterpenes.

As used herein, “peppermint oil” refers to both extracted and synthetic versions of Mentha balsamea Wild, and derivatives thereof. Peppermint is a hybrid mint—a cross between watermint and spearmint. Peppermint oil has at least one of the following constituents: menthol, menthone, menthyl acetate, 1,8-cineol, menthofuranne, neomenthol, isomenthone, beta-caryophyllene, germacrene D, limonene, beta-pinene, and/or terpinene-4-ol, alpha-pinene.

As used herein, “cedarwood oil” refers to both extracted and synthetic oils produced from distilling the wood of a number of different junipers and cypresses (of the family (′upressaceae), and derivatives thereof. Cedarwood oil has at least one of the following constituents: α-pinene, α-thujene, Camphene, β-pinene, Sabinene, Myrcene, α-terpinene, Limonene, β-phellandrene, γ-terpinene, p-cymene, Terpinolene, Isolongifolene, β-cubebene, Linalool, α-longipinene, α-cedrene, α-barbatene, β-cedrene, Terpinen-4-ol, β-funebrene, cis-p-menth-2-en-1-ol, Thujopsene (widdrene), allo-aromadendrene, β-barbatene, trans-piperitol, Selina-4,11-diene, β-chamigrene, α-terpineol, Pseudowiddrene, Bicyclogermacrene, α-cuprenene, Thujopsadiene, δ-cadinene, ar-curcumene, β-cuprenene, Cuparene, Dehydro-β-ionone, 8,9-dehydroneolongifolene, α-cedrol, Widdrol, 3-thujopsanone, α-cadinol, α-cedrenal, α-bisabolol, and/or Thujopsenal, Mayurone.

The term “water” as used herein means an inert or fluid material, which can be inorganic or organic and of synthetic or natural origin, with which the active compound is mixed or formulated to facilitate its application to the host, area, or other object to be treated, or to facilitate its storage, transport and/or handling. In general, any of the materials customarily employed in formulating repellents, pesticides, herbicides, or fungicides, are suitable.

As used herein, the term “killing” or “kill” refers to the ability of at least one active ingredient in a composition to render an insect dead.

As used herein, the term “knocking down” or “knockdown” (kd) refers to the ability of the composition described herein to render an insect immobile. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease or irritate is severely curtailed during the period in which it is knocked down.

As used herein, the term “emulsifier,” or surfactant, refers to a substance that stabilizes an emulsion by increasing its kinetic stability and comprises a hydrophilic (water-soluble) portion and a lipophilic (oil-soluble) portion. Common examples of emulsifiers include, but are not limited to, sodium lauryl sulfate, saponin, ethoxylated alcohols, ethoxylated fatty esters, alkoxylated glycols, ethoxylated fatty acids, ethoxylated castor oil, glyceryl oleates, carboxylated alcohols, carboxylic acids, fatty acids, ethoxylated alkylphenols, fatty esters, sodium dodecylsulfide, other fatty acid-based surfactants, other natural or synthetic emulsifiers, and combinations thereof.

As used herein, the term “polyglyceryl oleate” refers to one or more derivatives of the ester of oleic acid and polyglycerin, including but are not limited to polyglyceryl-4-oleate, polyglyceryl-3-oleate, polyglyceryl-2-oleate, polyglyceryl-2-dioleate, polyglyceryl-5-oleate, polyglyceryl-6-oleate, polyglyceryl-6-dioleate, polyglyceryl-8-oleate, polyglyceryl-10-monooleate, polyglyceryl-10-dioleate, and any combinations thereof.

As used herein, the term “microemulsion” refers to a thermodynamically stable fluid. It is different from kinetically stable emulsions which will be break into oil and water over time. The particle size of microemulsions ranges from about 10 nm to about 300 nm. Because of the small particle sizes, microemulsions appear as clear or translucent solutions.

As used herein, the term “repelling” or “repel” refers to the ability of the compositions described herein to cause a pest or insect to deviate away from or avoid a surface, object or insect breeding site treated with said composition.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. Any of the embodiments described herein may be modified to include any of the structures, compositions, or methodologies disclosed in connection with different embodiments. The exclusive rights to all modifications which come within the scope of the appended claims are reserved.

### EXAMPLES

Formulations A-C(Examples 1-3) comprise: about 4.20% cedarwood oil; about 0.10% sesame oil; about 1.50% lemongrass oil; about 5.00% to about 10.0% isopropyl alcohol; about 2.80% to about 6.70% surfactant; about 77.0% to about 82.0% water; about 1.58% to about 2.00% salt, and about 0.54% to about 1.99% of at least one additive.

Formulation D (Example 4) comprise: about 4.20% cedarwood oil; about 0.10% sesame oil; about 1.50% peppermint oil; about 10.0% isopropyl alcohol; about 2.8% to about 4.5% surfactant; about 77% to about 82% water; about 1.58% to about 2.00% salt; and about 0.54% to about 1.99% of at least one additive.

Formulation E (Example 5) comprise: about 4.20% cedarwood oil; about 0.10% sesame oil; about 1.50% rosemary oil; about 10.0% isopropyl alcohol; about 2.80% to about 4.5% surfactant; about 77% to about 82% water; about 1.58% to about 2.00% salt; and about 0.54% to about 1.99% of at least one additive.

Formulations F (Example 6) comprise: about 5.70% cedarwood oil; about 0.1% sesame oil; about 10.0% isopropyl alcohol; about 2.80% to about 4.50% surfactant; about 77% to about 82% water; about 1.58% to about 2.00% salt; and about 0.54% to about 1.99% of at least one additive.

Formulation G (Example 7) comprises: about 6.00% rosemary oil; about 10.0% isopropyl alcohol; about 4.45% surfactant; about 77.0% water; about 2.00% salt; and about 0.49% at least one additive.

Formulation H (Example 8) comprises: about 1.50% cedarwood oil; about 4.50% lemongrass oil; about 10.0% isopropyl alcohol; about 4.45% surfactant; about 77.0% water; about 2.00% salt; and about 0.49% at least one additive.

Formulation I (Example 9) comprises: about 3.00% rosemary oil; about 3.00% lemongrass oil; about 10.0% isopropyl alcohol; about 4.45% surfactant; about 77.0% water; about 2.00% salt; and about 0.49% at least one additive.

Formulation J (Example 10) comprises: about 9.00% cedarwood oil; about 10.0% isopropyl alcohol; about 4.45% surfactant; about 74.0% water; about 2.00% salt; and about 0.49% at least one additive.

Formulation K (Example 11) comprises: about 4.20% cedarwood oil; about 1.50% lemongrass oil; about 10.0% isopropyl alcohol; about 2.25% secondary surfactant; about 79.55% water; about 2.00% salt; and about 0.49% at least one additive.

Formulation L (Example 12) comprises: about 4.20% cedarwood oil; about 1.50% lemongrass oil; about 10.0% isopropyl alcohol; about 2.20% primary surfactant; about 79.60% water; about 2.00% salt; and about 0.49% at least one additive.

Formulation M (Example 13) comprises: about 4.20% cedarwood oil; about 1.50% lemongrass oil; about 0.00% isopropyl alcohol; about 4.50% surfactant; about 87.35% water; about 2.00% salt; and about 0.49% at least one additive.

Formulation N (Example 14) comprises: about 4.20% cedarwood oil; about 1.50% lemongrass oil; about 10.0% isopropyl alcohol; about 4.50% surfactant; about 79.35% water; about 0.00% salt; and about 0.49% at least one additive.

### Experimental Procedures

### Insect/Arthropod Knockdown and Mortality Test

Test Room. Temperature, 80±7° F. (27±4° C.) with 50±20% relative humidity.

Treatment containers for test systems: ants, firebrats, and earwigs—plastic cup with filter paper on the bottom and appropriate lid; mosquitoes, spiders, moths, fruit flies, and house flies—an annular plastic container with opposing screened mesh suitable to contain insects.

Test Design. Five replicates of 10 insects or 35 replicates of 1 spider for spiders were conducted with each test substance with knockdown counts at various intervals based on test system noted below. Mortality counts were taken at 24 hrs post-treatment for all test systems. Same for the controls. Targeted spray distance was approximately 12 to 18 inches, as appropriate to wet the insect.

Preparation. Carpenter ants were maintained in a plastic container with food, water, and harborage. Just prior to testing the ants were individually collected and shaken into a plastic cup. Argentine and Pharaoh ants were collected from the rearing tray into a testing cup.

Insects and arthropods were observed to be healthy before testing commenced and were transferred to appropriate testing containers. Test Procedure. Lightly greased side walls of jars and placed filter paper in the bottom of the jars. Targeted spray distance was approximately 12 inches to 18 inches, as appropriate to wet the insect. The test system was introduced to the spray apparatus by placing treatment containers, one at a time, on a wire platform of the spray apparatus.

For the ants, beetles, earwigs, and firebrats: the open end of the plastic cup was placed toward the source of the test substance. For mosquitoes, flies, moths, and spiders: placed the annular plastic container with opposing screened mesh suitable to contain insects in holding clamps with screen facing the source of the test substance.

Following test substance application, the test systems were transferred into a glass jar with clean filter paper (intermediate container) for knockdown observation. Spiders were transferred into a clean annular plastic container with opposing screened mesh suitable to contain insects. Transfer of small insects was done with soft forceps, spoon, or paint brush, as appropriate.

Observation/Knockdown Counts: Knockdown is defined as a test system experiencing aberrant behavior, such as, on their back or side, unable to maintain a normal posture when righted and/or exhibiting leg twitching or similar involuntary movements of a moribund insect from which it may recover. Knockdown observed at the following intervals. Carpenter ants: 30 seconds, 3, and 5 minutes. Pharaoh ants, Argentine ants, Firebrats, and Earwigs: 30 seconds, 1, 3, and 5 minutes. House flies, Fruit Flies, and Moths: 10, 20, 30, 40, 50, 60, and 120 seconds. Mosquitoes: 10, 20, 30, 40, 50, and 60 seconds. Spiders: 30 seconds, 5 minutes, and 2 hours.

Mortality counts: 24+2 hours post treatment. Test system mortality is defined as dead insects/spiders (insects/spiders that do not move even after prodding). End of test was called as all treated test systems reached 100% by 24 hours.

### Cockroach Direct Spray Test

Test Room. Temperature 80±7° F. (27±4° C.) with 50±20% relative humidity. A spray platform with platform containment barrier allowing cockroaches to move freely following the spray treatment, a short confinement platform containment barrier to keep German cockroaches confined during spray treatment, or a tall confinement platform containment barrier to keep American cockroaches confined during spray treatment. The sides of all platform containment barriers and containers were coated with grease.

Test Design. Five replicates for the German cockroaches and 10 replicates for American cockroaches with each test substance was conducted with knockdown counts at 30 seconds, 2 minutes, and 5 minutes. Insects were freed from the confinement platform containment barrier by removing it after spray. Mortality counts were taken at 24, 48, 72, and 96+2 hours post treatment. Targeted spray distance was approximately 12 inches to 18 inches from the test system and the test substance is sprayed directly at the test system.

Preparation. Holding containers (i.e., plastic cups with lids) are lightly greased and cockroaches were exposed to CO₂. Cockroaches were sorted by sex and ten adult German cockroach males and five adult American cockroach males were placed into each holding cup. American roaches were covered with a screen lid.

Test Procedure. Lightly greased side walls of platform containment barriers and set-up platform for testing. Placed the large platform containment barrier on the platform. In center of the platform, appropriate platform containment barriers were placed over a vinyl panel. Targeted spray distance was approximately 12 inches to 18 inches. The test substance was weighed before and after spraying to determine the actual dosage.

Prior to test substance application, the cockroaches were transferred from the holding container to the confinement platform. Twenty seconds after application of the test substance, the platform containment barrier was lifted allowing cockroaches to run freely on the platform.

Observation/Knockdown Counts. Cockroach knockdown is defined as cockroaches experiencing some aberrant behavior such as on their back or side, unable to maintain a normal posture when righted, and/or leg twitching or similar involuntary movements of a moribund insect. Cockroach knockdown was measured at thirty second, 2-minute, and 5-minute intervals. After up to 15 minutes, cockroaches were then transferred into clean greased holding containers with screen lids and provided with food and a water-soaked wick.

### Observation Counts Consist of Three Classifications:

Alive Cockroaches: alive cockroaches are defined as insects that respond with movement when prodded.

Knockdown Cockroaches: knockdown cockroaches are defined when the cockroach is rendered incapable of coordinated movement or unable to right itself following exposure to a pesticide product (e.g., on its back with only a single appendage twitching).

Dead Cockroaches: dead cockroaches are defined as cockroaches that do not respond with movement of any kind when prodded.

### Tick Direct Spray Test

Test Room. Temperature 80±7° F. (27±4° C.) with 50±20% relative humidity.

Five replicates with test substance were conducted. Mortality counts were taken at 24, 48, 72, and 96±2-hours each post treatment. Ticks were maintained in a plastic container with water and harborage. Prior to testing the ticks were individually collected and transferred to a plastic cup.

Test Procedure. Targeted spray distance was approximately 12 inches to 18 inches from the test system. The test substance was weighed before and after spraying to determine the actual dosage. The test system was introduced to the spray apparatus by placing treatment containers, one at a time, on a wire platform of the spray apparatus, open end of the plastic cup facing the test substance.

Mortality counts: 24, 48, 72, and 96±2 hour. Tick mortality is defined as a dead tick (ticks that do not move even after prodding or exhaling upon).

Flea Direct Spray Test (Cat fleas (Ctenocephalides felis))

Test Room. Temperature 80±7° F. (27±4° C.) with 50±20% relative humidity.

Four replicates with test substance were conducted with mortality counts taken at 24, 48, 72, and 96 all ±2 hours post treatment. Target distance was from approximately 3″ from top of a pail, approximately 18″ from insects at the bottom.

Insect set-up. Fleas were placed in a vial and exposed to CO₂. Twenty fleas were counted and placed in a separate vial. Five vials of 20 fleas each (for 4 reps+1 control) were prepared for each sample.

Test Procedure. The test substance was sprayed directly on the test system. The test substance was weighed before and after spraying to determine the dosage. Immediately prior to applying test substance, the vial of fleas was emptied into the plastic pail. The pail is positioned at an angle of approximately 45° towards the source of the spray. Following treatment, the pail was removed and set aside for mortality counts. After one hour, a filter paper circle cut to the size of the pail bottom surface area was placed in the pail. For the mortality counts, the filter paper was lifted and tapped/shaken to ensure the fleas are dropped back to the bottom.

Mortality. Dead insects are insects that will not move when disturbed.

### Examples 1-3

The following ingredients in Table 1 are combined to prepare formulations A-C.

TABLE 1
Components of formulations A-C.

| | Formulation A | Formulation B | Formulation C |
|---|---|---|---|
| | (Example 1) | (Example 2) | (Example 3) |
| Ingredient | (wt %) | (wt %) | (wt %) |
| Cedarwood Oil | 4.20 | 4.20 | 4.20 |
| Lemongrass Oil | 1.50 | 1.50 | 1.50 |
| Rosemary Oil | — | — | — |
| Peppermint Oil | — | — | — |
| Sesame Oil | 0.10 | 0.10 | 0.10 |
| Mixed Tocopherols | 0.05 | 0.05 | 0.05 |
| (Vitamin E) | | | |
| Glycerin | 0.50 | 0.50 | 0.50 |
| Polyglyceryl Oleate | — | — | — |
| Citric Acid | — | — | — |
| Trisodium Citrate | — | — | — |
| Dihydrate | | | |
| Sodium Lauryl | 2.20 | 2.20 | 2.20 |
| Sulfate | | | |
| Sodium Chloride | 2.00 | 2.00 | 2.00 |
| Water | 77.20 | 79.95 | 77.45 |
| Isopropyl Alcohol | 10.00 | 5.00 | 10.00 |
| Polyglyceryl-4- | 2.25 | 4.50 | |
| Oleate | | | |
| Decaglycerol | — | — | 2.00 |
| Monostearate | | | |
| Total | 100 | 100 | 100 |

### Example 4

The following ingredients in Table 2 are combined to prepare formulation D.

TABLE 2
Components of formulations D.

| Ingredient | Formulation D (Example 4) (wt %) |
|---|---|
| Cedarwood Oil | 4.20 |
| Lemongrass Oil | — |
| Rosemary Oil | — |
| Peppermint Oil | 1.50 |
| Sesame Oil | 0.10 |
| Mixed Tocopherols (Vitamin E) | 0.05 |
| Glycerin | 0.50 |
| Polyglyceryl Oleate | — |
| Citric Acid | — |
| Trisodium Citrate Dihydrate | — |
| Sodium Lauryl Sulfate | 2.20 |
| Sodium Chloride | 2.00 |
| Water | 77.20 |
| Isopropyl Alcohol | 10.0 |
| Polyglyceryl-4-Oleate | 2.25 |
| Decaglycerol Monostearate | — |
| Total | 100 |

### Example 5

The following ingredients in Table 3 are combined to prepare formulation E.

TABLE 3
Components of formulations E.

| | Formulation E |
|---|---|
| | (Example 5) |
| Ingredient | (wt %) |
| Cedarwood Oil | 4.20 |
| Lemongrass Oil | — |
| Rosemary Oil | 1.50 |
| Peppermint Oil | — |
| Sesame Oil | 0.10 |
| Mixed Tocopherols (Vitamin E) | 0.05 |
| Glycerin | 0.50 |
| Polyglyceryl Oleate | — |
| Citric Acid | — |
| Trisodium Citrate Dihydrate | — |
| Sodium Lauryl Sulfate | 2.20 |
| Sodium Chloride | 2.00 |
| Water | 77.20 |
| Isopropyl Alcohol | 10.0 |
| Polyglyceryl-4-Oleate | 2.25 |
| Decaglycerol Monostearate | — |
| Total | 100 |

### Example 6

The following ingredients in Table 4 are combined to prepare formulation F.

TABLE 4
Components of formulations F.

| | Formulation F |
|---|---|
| | (Example 6) |
| Ingredient | (wt %) |
| Cedarwood Oil | 5.70 |
| Lemongrass oil | — |
| Rosemary Oil | — |
| Peppermint Oil | — |
| Sesame Oil | 0.10 |
| Mixed Tocopherols (Vitamin E) | 0.05 |
| Glycerin | 0.50 |
| Polyglyceryl Oleate | — |
| Citric Acid | — |
| Trisodium Citrate Dihydrate | — |
| Sodium Lauryl Sulfate | 2.20 |
| Sodium Chloride | 2.00 |
| Water | 77.20 |
| Isopropyl Alcohol | 10.0 |
| Polyglyceryl-4-Oleate | 2.25 |
| Decaglycerol Monostearate | — |
| Total | 100 |

### Example 7

The following ingredients in Table 5 are combined to prepare formulation G.

TABLE 5
Components of formulation G

| | Formulation G |
|---|---|
| | (Example 7) |
| Ingredient | (wt %) |
| Cedarwood Oil | — |
| Lemongrass oil | — |
| Rosemary Oil | 6.00 |
| Peppermint Oil | — |
| Sesame Oil | — |
| Mixed Tocopherols (Vitamin E) | — |
| Glycerin | 0.50 |
| Polyglyceryl Oleate | — |
| Citric Acid | — |
| Trisodium Citrate Dihydrate | — |
| Sodium Lauryl Sulfate | 2.20 |
| Sodium Chloride | 2.00 |
| Water | 77.05 |
| Isopropyl Alcohol | 10.0 |
| Polyglyceryl-4-Oleate | 2.25 |
| Decaglycerol Monostearate | — |
| Total | 100 |

### Example 8

The following ingredients in Table 6 are combined to prepare formulation H.

TABLE 6
Components of formulation H

| | Formulation H |
|---|---|
| | (Example 8) |
| Ingredient | (wt %) |
| Cedarwood Oil | 1.50 |
| Lemongrass oil | 4.50 |
| Rosemary Oil | — |
| Peppermint Oil | — |
| Sesame Oil | — |
| Mixed Tocopherols (Vitamin E) | — |
| Glycerin | 0.50 |
| Polyglyceryl Oleate | — |
| Citric Acid | — |
| Trisodium Citrate Dihydrate | — |
| Sodium Lauryl Sulfate | 2.20 |
| Sodium Chloride | 2.00 |
| Water | 77.05 |
| Isopropyl Alcohol | 10.0 |
| Polyglyceryl-4-Oleate | 2.25 |
| Decaglycerol Monostearate | — |
| Total | 100 |

### Example 9

The following ingredients in Table 7 are combined to prepare formulation I.

TABLE 7
Components of formulation I

| | Formulation I |
|---|---|
| | (Example 9) |
| Ingredient | (wt %) |
| Cedarwood Oil | — |
| Lemongrass oil | 3.00 |
| Rosemary Oil | 3.00 |
| Peppermint Oil | — |
| Sesame Oil | — |
| Mixed Tocopherols (Vitamin E) | — |
| Glycerin | 0.50 |
| Polyglyceryl Oleate | — |
| Citric Acid | — |
| Trisodium Citrate Dihydrate | — |
| Sodium Lauryl Sulfate | 2.20 |
| Sodium Chloride | 2.00 |
| Water | 77.05 |
| Isopropyl Alcohol | 10.0 |
| Polyglyceryl-4-Oleate | 2.25 |
| Decaglycerol Monostearate | — |
| Total | 100 |

### Example 10

The following ingredients in Table 8 are combined to prepare formulation J.

TABLE 8
Components of formulation J

| | Formulation J |
|---|---|
| | (Example 10) |
| Ingredient | (wt %) |
| Cedarwood Oil | 9.00 |
| Lemongrass oil | — |
| Rosemary Oil | — |
| Peppermint Oil | — |
| Sesame Oil | — |
| Mixed Tocopherols (Vitamin E) | — |
| Glycerin | 0.50 |
| Polyglyceryl Oleate | — |
| Citric Acid | — |
| Trisodium Citrate Dihydrate | — |
| Sodium Lauryl Sulfate | 2.20 |
| Sodium Chloride | 2.00 |
| Water | 74.05 |
| Isopropyl Alcohol | 10.0 |
| Polyglyceryl-4-Oleate | 2.25 |
| Decaglycerol Monostearate | — |
| Total | 100 |

### Example 11

The following ingredients in Table 9 are combined to prepare formulation K.

TABLE 9
Components of formulation K

| | Formulation K |
|---|---|
| | (Example 11) |
| Ingredient | (wt %) |
| Cedarwood Oil | 4.20% |
| Lemongrass oil | 1.50% |
| Rosemary Oil | — |
| Peppermint Oil | — |
| Sesame Oil | — |
| Mixed Tocopherols (Vitamin E) | — |
| Glycerin | 0.50% |
| Polyglyceryl Oleate | — |
| Citric Acid | — |
| Trisodium Citrate Dihydrate | — |
| Sodium Lauryl Sulfate | — |
| Sodium Chloride | 2.00% |
| Water | 79.55% |
| Isopropyl Alcohol | 10.00% |
| Polyglyceryl-4-Oleate | 2.25% |
| Decaglycerol Monostearate | — |
| Total | 100 |

### Example 12

The following ingredients in Table 10 are combined to prepare formulation L.

TABLE 10
Components of formulation L

| | Formulation L |
|---|---|
| | (Example 12) |
| Ingredient | (wt %) |
| Cedarwood Oil | 4.20% |
| Lemongrass oil | 1.50% |
| Rosemary Oil | — |
| Peppermint Oil | — |
| Sesame Oil | — |
| Mixed Tocopherols (Vitamin E) | — |
| Glycerin | 0.50% |
| Polyglyceryl Oleate | — |
| Citric Acid | — |
| Trisodium Citrate Dihydrate | — |
| Sodium Lauryl Sulfate | 2.20% |
| Sodium Chloride | 2.00% |
| Water | 79.60% |
| Isopropyl Alcohol | 10.00% |
| Polyglyceryl-4-Oleate | — |
| Decaglycerol Monostearate | — |
| Total | 100 |

### Example 13

The following ingredients in Table 11 are combined to prepare formulation M.

TABLE 11
Components of formulation M

| | Formulation M |
|---|---|
| | (Example 13) |
| Ingredient | (wt %) |
| Cedarwood Oil | 4.20% |
| Lemongrass oil | — |
| Rosemary Oil | — |
| Peppermint Oil | — |
| Sesame Oil | — |
| Mixed Tocopherols (Vitamin E) | — |
| Glycerin | 0.50% |
| Polyglyceryl Oleate | — |
| Citric Acid | — |
| Trisodium Citrate Dihydrate | — |
| Sodium Lauryl Sulfate | 2.20% |
| Sodium Chloride | 2.00% |
| Water | 87.35% |
| Isopropyl Alcohol | — |
| Polyglyceryl-4-Oleate | 2.25% |
| Decaglycerol Monostearate | — |
| Total | 100 |

### Example 14

The following ingredients in Table 12 are combined to prepare formulation N.

TABLE 12
Components of formulation N

| Ingredient | Formulation N (Example 14) (wt %) |
|---|---|
| Cedarwood Oil | 4.20% |
| Lemongrass oil | 1.50% |
| Rosemary Oil | — |
| Peppermint Oil | — |
| Sesame Oil | — |
| Mixed Tocopherols (Vitamin E) | — |
| Glycerin | 0.50% |
| Polyglyceryl Oleate | — |
| Citric Acid | — |
| Trisodium Citrate Dihydrate | — |
| Sodium Lauryl Sulfate | 2.20% |
| Sodium Chloride | — |
| Water | 79.35% |
| Isopropyl Alcohol | 10.0% |
| Polyglyceryl-4-Oleate | 2.25% |
| Decaglycerol Monostearate | — |
| Total | 100 |

Formulations K-N in Examples 11-14 (Tables 9-12) demonstrate formulations that do not form stable emulsions. Formulation K does not contain a primary surfactant, (i.e., sodium lauryl sulfate). Formulation L contains no secondary surfactant, (i.e., polyglyceryl-4-oleate, polyglyceryl oleate, decaglycerol monostearate). Formulation M lacks alcohol (i.e., isopropyl alcohol). Formulation N lacks salt (i.e., sodium chloride). Taken together, Formulations K-N demonstrate that compositions lacking any one of a primary surfactant, secondary surfactant, alcohol, or salt, results in an unstable emulsion not capable of forming a clear, thermodynamically stable homogenous phase at room temperature.

Formulation K, lacking a primary surfactant, has an unevenly split two-phase separation. The larger (by volume) of the two phases appears white and cloudy. The smaller (by volume) of the two phases is located above the larger phase and is amber in color.

Formulation L, lacking a secondary surfactant, has an unevenly split two-phase separation. The larger (by volume) of the two phases appears colorless and with a white precipitate. The smaller (by volume) of the two phases is located above the larger phase and is amber in color.

Formulation M, lacking alcohol, has an unevenly split two-phase separation. The larger (by volume) of the two phases appears white and cloudy. The smaller (by volume) of the two phases is located above the larger phase and is pale amber in color. There appears to be a white precipitate at the interface between the two phases. There are bubbles on the top surface and within the upper, smaller phase.

Formulation N, lacking salt, has an unevenly split two-phase separation. The larger (by volume) of the two phases appears colorless and with white-to-yellow precipitate throughout. There appears to be a white precipitate at the interface between the two phases. The smaller (by volume) phase is located above the larger phase, is amber in color, and is cloudy.

TABLE 13
Efficacy data for formulations A-J. Mean percent knocked down, and standard error of the mean (SEM) are given for 10 seconds, 20 seconds, 30
seconds, 40 seconds, 50 seconds, 60 seconds, and 120 seconds post-exposure. Mean percent mortality is given after 24 hours post-exposure.

| | | | | | | | | | | | | | | | | Mean % | |
|---|---|---|---|---|---|---|---|---|---|---|---|---|---|---|---|---|---|
| | mean | Mean % Knockdown | | | | | | | | | | | | | | Mortality | |
| | amount | | | | | | | | | | | | | | | 24 hrs | |
| | dispensed | 10 sec | | 20 sec | | 30 sec | | 40 sec | | 50 sec | | 60 sec | | 120 sec | | % | |
| Formula | wt (g) | % kd | SEM | % kd | SEM | % kd | SEM | % kd | SEM | % kd | SEM | % kd | SEM | % kd | SEM | dead | SEM |

Mean % Knocked Down and Mean % Mortality Results for Direct Spray of India Meal Moth (Plodia interpunctella)

| | | | | | | | | | | | | | | | | | |
|---|---|---|---|---|---|---|---|---|---|---|---|---|---|---|---|---|---|
| A-C | 4.34 | 100 | 0 | 100 | 0 | 100 | 0 | 100 | 0 | 100 | 0 | 100 | 0 | 100 | 0 | 100 | 0 |
| D | 4.14 | 100 | 0 | 100 | 0 | 100 | 0 | 100 | 0 | 100 | 0 | 100 | 0 | 100 | 0 | 100 | 0 |
| E | 4.16 | 100 | 0 | 100 | 0 | 100 | 0 | 100 | 0 | 100 | 0 | 100 | 0 | 100 | 0 | 100 | 0 |
| F | 4.37 | 100 | 0 | 100 | 0 | 100 | 0 | 100 | 0 | 100 | 0 | 100 | 0 | 100 | 0 | 100 | 0 |
| Untreated Control | na | na | na | na | na | na | na | na | na | na | na | na | na | na | na | 94 | 4 |

Mean % Knocked Down and Mean % Mortality Results for Direct Spray of House Fly (Musca domestica)

| | | | | | | | | | | | | | | | | | |
|---|---|---|---|---|---|---|---|---|---|---|---|---|---|---|---|---|---|
| A-C | 4.33 | 24 | 4 | 42 | 2 | 64 | 6 | 74 | 2 | 80 | 4 | 86 | 2 | 100 | 0 | 100 | 0 |
| D | 4.12 | 34 | 2 | 52 | 5 | 70 | 7 | 76 | 5 | 86 | 4 | 90 | 4 | 98 | 2 | 100 | 0 |
| E | 4.22 | 22 | 4 | 28 | 2 | 40 | 3 | 64 | 4 | 66 | 4 | 74 | 2 | 98 | 2 | 100 | 0 |
| F | 4.41 | 22 | 4 | 38 | 9 | 52 | 13 | 52 | 12 | 56 | 13 | 64 | 7 | 88 | 4 | 100 | 0 |
| G | 4.01 | 58 | 9 | 80 | 9 | 84 | 9 | 92 | 5 | 92 | 5 | 96 | 4 | 96 | 4 | 100 | 0 |
| H | 4.17 | 42 | 8 | 72 | 10 | 94 | 10 | 96 | 10 | 98 | 2 | 98 | 2 | 100 | 0 | 100 | 0 |
| I | 4.19 | 54 | 5 | 92 | 4 | 98 | 2 | 98 | 2 | 100 | 0 | 100 | 0 | 100 | 0 | 100 | 0 |
| J | 4.19 | 30 | 3 | 44 | 2 | 54 | 4 | 60 | 6 | 52 | 8 | 66 | 6 | 82 | 7 | 100 | 0 |
| Untreated Control | na | na | na | na | na | na | na | na | na | na | na | na | na | na | na | 4 | 4 |

Mean % Knocked Down and Mean % Mortality Results for Direct Spray of Fruit Fly (Drosophila melanogaster)

| | | | | | | | | | | | | | | | | | |
|---|---|---|---|---|---|---|---|---|---|---|---|---|---|---|---|---|---|
| A-C | 4.33 | 100 | 0 | 100 | 0 | 100 | 0 | 100 | 0 | 100 | 0 | 100 | 0 | 100 | 0 | 100 | 0 |
| D | 4.21 | 100 | 0 | 100 | 0 | 100 | 0 | 100 | 0 | 100 | 0 | 100 | 0 | 98 | 2 | 100 | 0 |
| E | 4.20 | 100 | 0 | 100 | 0 | 100 | 0 | 100 | 0 | 100 | 0 | 100 | 0 | 100 | 0 | 100 | 0 |
| F | 4.37 | 100 | 0 | 100 | 0 | 100 | 0 | 100 | 0 | 100 | 0 | 100 | 0 | 100 | 0 | 100 | 0 |
| Untreated Control | na | na | na | na | na | na | na | na | na | na | na | na | na | na | na | 0 | 0 |

Mean % Knocked Down and Mean % Mortality Results for Direct Spray of Aedes aegypti Mosquito (Aedes aegypti)

| | | | | | | | | | | | | | | | | | |
|---|---|---|---|---|---|---|---|---|---|---|---|---|---|---|---|---|---|
| A-C | 4.22 | 100 | 0 | 100 | 0 | 100 | 0 | 100 | 0 | 100 | 0 | 100 | 0 | 100 | 0 | 100 | 0 |
| D | 4.17 | 100 | 0 | 100 | 0 | 100 | 0 | 100 | 0 | 100 | 0 | 100 | 0 | 100 | 0 | 100 | 0 |
| E | 4.19 | 100 | 0 | 100 | 0 | 100 | 0 | 100 | 0 | 100 | 0 | 100 | 0 | 100 | 0 | 100 | 0 |
| F | 4.06 | 100 | 0 | 100 | 0 | 100 | 0 | 100 | 0 | 100 | 0 | 100 | 0 | 100 | 0 | 100 | 0 |
| G | 3.86 | 100 | 0 | 100 | 0 | 100 | 0 | 100 | 0 | 100 | 0 | 100 | 0 | 100 | 0 | 100 | 0 |
| H | 4.13 | 100 | 0 | 100 | 0 | 100 | 0 | 100 | 0 | 100 | 0 | 100 | 0 | 100 | 0 | 100 | 0 |
| I | 4.10 | 100 | 0 | 100 | 0 | 100 | 0 | 100 | 0 | 100 | 0 | 100 | 0 | 100 | 0 | 100 | 0 |
| J | 4.34 | 100 | 0 | 100 | 0 | 100 | 0 | 100 | 0 | 100 | 0 | 100 | 0 | 100 | 0 | 100 | 0 |
| Untreated Control | na | na | na | na | na | na | na | na | na | na | na | na | na | na | na | 0 | 0 |

Mean % Knocked Down and Mean % Mortality Results for Direct Spray of German Cockroach (Blatella germanica)

| | | Mean % Knockdown | | | | | | Mean % Mortality | |
|---|---|---|---|---|---|---|---|---|---|
| | mean amount | 30 sec | | 2 min | | 5 min | | 24 hrs | |
| Scent | dispensed wt (g) | % kd | SEM | % kd | SEM | % kd | SEM | % dead | SEM |
| A-C | 3.94 | 100 | 0 | 100 | 0 | 100 | 0 | 100 | 0 |
| D | 4.23 | 100 | 0 | 100 | 0 | 100 | 0 | 100 | 0 |
| E | 4.63 | 100 | 0 | 100 | 0 | 100 | 0 | 100 | 0 |
| F | 4.17 | 100 | 0 | 100 | 0 | 100 | 0 | 100 | 0 |
| G | 4.10 | 100 | 0 | 100 | 0 | 100 | 0 | 100 | 0 |
| H | 4.25 | 100 | 0 | 100 | 0 | 100 | 0 | 100 | 0 |
| I | 3.80 | 100 | 0 | 100 | 0 | 100 | 0 | 100 | 0 |
| J | 4.34 | 96 | 0 | 100 | 0 | 100 | 0 | 100 | 0 |
| Untreated Control | na | na | na | na | na | na | na | 0 | 0 |

Mean % Knocked Down and Mean % Mortality Results Direct Spray of American Cockroach (Periplaneta americana)

| | | Mean % Knockdown | | | | | | Mean % Mortality | |
|---|---|---|---|---|---|---|---|---|---|
| | mean amount | 30 sec | | 2 min | | 5 min | | 24 hrs | |
| Scent/Formula | dispensed wt (g) | % kd | SEM | % kd | SEM | % kd | SEM | % dead | SEM |
| A-C | 4.14 | 30 | 5 | 62 | 6 | 78 | 7 | 94 | 3 |
| D | 4.21 | 30 | 3 | 64 | 6 | 76 | 4 | 96 | 3 |
| E | 4.26 | 20 | 5 | 56 | 7 | 72 | 7 | 98 | 2 |
| F | 4.18 | 26 | 8 | 50 | 9 | 64 | 10 | 94 | 4 |
| Untreated Control | na | na | na | na | na | na | na | 0 | 0 |

| | | Mean % Knockdown | | | | | | Mean % Mortality | |
|---|---|---|---|---|---|---|---|---|---|
| | mean amount | 30 sec | | 3 min | | 5 min | | 24 hrs | |
| Formula | dispensed wt (g) | % kd | SEM | % kd | SEM | % kd | SEM | % dead | SEM |

Mean % Knocked Down and Mean % Mortality Results for Direct Spray of Common House Spider (Parasteatoda tepidariorum)

| | | | | | | | | | |
|---|---|---|---|---|---|---|---|---|---|
| A-C | 4.14 | 0 | 0 | 100 | 0 | 100 | 0 | 100 | 0 |
| D | 4.18 | 0 | 0 | 97 | 3 | 100 | 0 | 100 | 0 |
| E | 4.23 | 3 | 3 | 97 | 3 | 100 | 0 | 100 | 0 |
| F | 4.20 | 0 | 0 | 100 | 0 | 100 | 0 | 100 | 0 |
| Untreated Control | na | na | na | na | na | na | na | 0 | 0 |

Mean % Knocked Down and Mean % Mortality Results for Direct Spray of Carpenter Ant (Camponotus floridanus)

| | | | | | | | | | |
|---|---|---|---|---|---|---|---|---|---|
| A-C | 3.87 | 94 | 4 | 98 | 2 | 100 | 0 | 100 | 0 |
| D | 4.15 | 96 | 4 | 100 | 0 | 100 | 0 | 100 | 0 |
| E | 4.13 | 98 | 2 | 100 | 0 | 100 | 0 | 100 | 0 |
| F | 4.16 | 100 | 0 | 100 | 0 | 100 | 0 | 100 | 0 |
| G | 3.93 | 98 | 2 | 100 | 0 | 100 | 0 | 100 | 0 |
| H | 4.25 | 100 | 0 | 100 | 0 | 100 | 0 | 100 | 0 |
| I | 4.16 | 100 | 0 | 100 | 0 | 100 | 0 | 100 | 0 |
| J | 4.17 | 90 | 6 | 100 | 0 | 100 | 0 | 100 | 0 |
| Untreated Control | na | na | na | na | na | na | na | 0 | 0 |

| | | Mean % Knockdown | | | | | | | | Mean % Mortality | |
|---|---|---|---|---|---|---|---|---|---|---|---|
| | mean amount | 30 sec | | 1 min | | 3 min | | 5 min | | 24 hrs | |
| Scent/Formula | dispensed wt (g) | % kd | SEM | % kd | SEM | % kd | SEM | % kd | SEM | % dead | SEM |

Mean Knocked Down and Mortality Results for Direct Spray of Argentine Ant (Linepithema humile)

| | | | | | | | | | | | |
|---|---|---|---|---|---|---|---|---|---|---|---|
| A-C | 3.81 | 100 | 0 | 100 | 0 | 100 | 0 | 100 | 0 | 100 | 0 |
| D | 4.20 | 100 | 0 | 100 | 0 | 100 | 0 | 100 | 0 | 100 | 0 |
| E | 4.26 | 100 | 0 | 100 | 0 | 100 | 0 | 100 | 0 | 100 | 0 |
| F | 4.15 | 100 | 0 | 100 | 0 | 100 | 0 | 100 | 0 | 100 | 0 |
| Untreated Control | na | na | na | na | na | na | na | na | na | 4 | 4 |

Mean Knocked Down and Mortality Results for Direct Spray of Pharaoh Ant (Monomorium pharaonis)

| | | | | | | | | | | | |
|---|---|---|---|---|---|---|---|---|---|---|---|
| A-C | 3.53 | 100 | 0 | 100 | 0 | 100 | 0 | 100 | 0 | 100 | 0 |
| D | 4.22 | 100 | 0 | 100 | 0 | 100 | 0 | 100 | 0 | 100 | 0 |
| E | 4.22 | 100 | 0 | 100 | 0 | 100 | 0 | 100 | 0 | 100 | 0 |
| F | 4.17 | 100 | 0 | 100 | 0 | 100 | 0 | 100 | 0 | 100 | 0 |
| Untreated Control | na | na | na | na | na | na | na | na | na | 0 | 0 |

Knocked Down and Mortality for Direct Spray of Firebrat (Thermobia domestica)

| | | | | | | | | | | | |
|---|---|---|---|---|---|---|---|---|---|---|---|
| A-C | 4.29 | 100 | 0 | 100 | 0 | 100 | 0 | 100 | 0 | 100 | 0 |
| D | 4.22 | 100 | 0 | 100 | 0 | 100 | 0 | 100 | 0 | 100 | 0 |
| E | 4.11 | 100 | 0 | 100 | 0 | 100 | 0 | 100 | 0 | 100 | 0 |
| F | 4.34 | 100 | 0 | 100 | 0 | 100 | 0 | 100 | 0 | 100 | 0 |
| Untreated Control | na | na | na | na | na | na | na | na | na | 2 | 0 |

Knocked Down and Mortality Results for Direct Spray of Earwig (Euborellia annulipes)

| | | | | | | | | | | | |
|---|---|---|---|---|---|---|---|---|---|---|---|
| A-C | 3.57 | 100 | 0 | 100 | 0 | 100 | 0 | 100 | 0 | 100 | 0 |
| D | 4.18 | 96 | 2 | 100 | 0 | 100 | 0 | 100 | 0 | 100 | 0 |
| E | 4.04 | 96 | 2 | 100 | 0 | 100 | 0 | 100 | 0 | 100 | 0 |
| F | 4.12 | 90 | 3 | 100 | 0 | 100 | 0 | 100 | 0 | 100 | 0 |
| Untreated Control | na | na | na | na | na | na | na | na | na | 0 | 0 |

| | |
|---|---|
| mean amount | Mean % Mortality 24 hrs |

| | | | |
|---|---|---|---|
| Scent/Formula | dispensed wt (g) | % dead | SEM |

Mean Mortality Results for Direct Spray of Brown Dog Tick (Rhipicephalus sanguineus)

| | | | |
|---|---|---|---|
| A-C | 3.76 | 100 | 0 |
| D | 4.21 | 100 | 0 |
| E | 4.16 | 100 | 0 |
| F | 4.19 | 100 | 0 |
| Untreated Control | na | 0 | 0 |

Mean Mortality Results for Direct Spray of Cat Flea (Ctenocephalides felis)

| | | | |
|---|---|---|---|
| A-C | 4.31 | 100 | 0 |
| D | 4.21 | 100 | 0 |
| E | 4.16 | 100 | 0 |
| F | 4.33 | 100 | 0 |
| Untreated Control | na | 0 | 0 |

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A pest control composition comprising:
at least one active component comprising one or more essential oils;
a total surfactant component comprising a primary surfactant and at least one secondary surfactant;
about 5.00 wt % to about 10.00 wt % isopropyl alcohol;
about 2.00 wt % sodium chloride; and
about 60.00 wt % to about 90.00 wt % water.

2. The composition of claim 1, wherein the at least one active component is selected from the group consisting of cedarwood oil, lemongrass oil, rosemary oil, peppermint oil, sesame oil, and combinations thereof.

3. The composition of claim 2, wherein the total amount of the at least one active component comprises about 5.80 wt % to about 9.00 wt %, based on the total weight of the composition.

4. The composition of claim 1, wherein the primary surfactant is sodium lauryl sulfate.

5. The composition of claim 4, wherein the secondary surfactant is selected from the group consisting of polyglyceryl-4-oleate, polyglyceryl oleate, decaglycerol monostearate, and combinations thereof.

6. The composition of claim 5, wherein the total surfactant component comprises about 2.80 wt % to about 6.70 wt %, based on the total weight of the composition.

7. The composition of claim 1, further comprising at least one additive selected from the group consisting of glycerin, mixed tocopherols (Vitamin E), and combinations thereof.

8. The composition of claim 7, wherein the at least one additive comprises about 0.20 wt % to about 2.00 wt %, based on the total weight of the composition.

9. The composition of claim 8, wherein the at least one additive comprises 0.50 wt % glycerin, based on the total weight of the composition.

10. A pest control composition comprising:
at least one active component comprising one or more essential oils;
a total surfactant component comprising a primary surfactant and a secondary surfactant;
about 5.00 wt % to about 10.00 wt % isopropyl alcohol;
about 2.00 wt % sodium chloride; and
about 60.00 wt % to about 90.00 wt % water;
wherein the composition has an insect knockdown rate at 30 seconds greater than or equal to about 90% against the India Meal moth, Fruit fly, Mosquito, Carpenter ant, Argentine ant, Pharoah ant, Firebrat, Earwig, House fly, and German cockroach, as measured by the Insect/Arthropod Knockdown and Mortality Test and the Cockroach Direct Spray Test, respectively.

11. The composition of claim 10, wherein the composition has an insect mortality rate at 24 hours of greater than about 90% against American cockroach, and 100% against German cockroach, as measured by the Cockroach Direct Spray Test.

12. The composition of claim 10, wherein the at least one active component is selected from the group consisting of cedarwood oil, lemongrass oil, rosemary oil, peppermint oil, sesame oil, and combinations thereof.

13. The composition of claim 12, wherein the total amount of at the least one active component comprises about 5.80 wt % to about 9.00 wt %, based on the total weight of the composition.

14. The composition of claim 10, wherein the primary surfactant is sodium lauryl sulfate.

15. The composition of claim 14, wherein the secondary surfactant is selected from the group consisting of polyglyceryl-4-oleate, polyglyceryl oleate, decaglycerol monostearate, and combinations thereof.

16. The composition of claim 15, wherein the total surfactant component comprises about 2.80 wt % to about 6.70 wt %, based on the total weight of the composition.

17. The composition of claim 10, further comprising at least one additive selected from the group consisting of glycerin, mixed tocopherols (Vitamin E), and combinations thereof.

18. The composition of claim 17, wherein the at least one additive comprises about 0.20 wt % to about 2.00 wt %, based on the total weight of the composition.

19. The composition of claim 18, wherein the at least one additive comprises 0.50 wt % glycerin, based on the total weight of the composition.

20. A method of killing insects comprising applying to a surface in need thereof a composition comprising:
at least one active component comprising one or more essential oils;
a total surfactant component comprising a primary surfactant and a secondary surfactant;
about 5.00 wt % to about 10.00 wt % isopropyl alcohol;
about 2.00 wt % sodium chloride; and
about 60.00 wt % to about 90.00 wt % water.

21. A pest control composition comprising:
at least one active component comprising one or more essential oils;
a total surfactant component comprising a primary surfactant and at least one secondary surfactant;
about 2.00 wt % to about 15.00 wt % isopropyl alcohol;
about 0.50 wt % to about 3.00 wt % sodium chloride; and
about 60.00 wt % to about 90.00 wt % water.

22. The composition of claim 21, wherein the at least one active component is selected from the group consisting of cedarwood oil, lemongrass oil, rosemary oil, peppermint oil, sesame oil, and combinations thereof.

23. The composition of claim 22, wherein the total amount of the at least one active component comprises about 5.80 wt % to about 9.00 wt %, based on the total weight of the composition.

24. The composition of claim 21, wherein the primary surfactant is sodium lauryl sulfate.

25. The composition of claim 24, wherein the secondary surfactant is selected from the group consisting of polyglyceryl-4-oleate, polyglyceryl oleate, decaglycerol monostearate, and combinations thereof.

26. The composition of claim 25, wherein the total surfactant component comprises about 2.80 wt % to about 6.70 wt %, based on the total weight of the composition.

27. The composition of claim 21, further comprising at least one additive selected from the group consisting of glycerin, mixed tocopherols (Vitamin E), and combinations thereof.

28. The composition of claim 27, wherein the at least one additive comprises about 0.20 wt % to about 2.00 wt %, based on the total weight of the composition.

29. The composition of claim 28, wherein the at least one additive comprises 0.50 wt % glycerin, based on the total weight of the composition.
